(19) United States
(12) Patent Application Publication
(10) Pub. No.: US 2016/0054731 A1
(43) Pub. Date: Feb. 25, 2016

(54) SYSTEMS, APPARATUS, AND METHODS FOR PROCESSING RECIPE PROTECTION AND SECURITY

(71) Applicant: Applied Materials, Inc., Santa Clara, CA (US)

(72) Inventors: James Hoffman, San Jose, CA (US); Atsushi Kitani, Nara (JP); Hong Soon Kim, Cupertino, CA (US); Young Taek Kwon, Gyeonggi (KR)

(21) Appl. No.: 14/716,802

(22) Filed: May 19, 2015

Related U.S. Application Data
(60) Provisional application No. 62/039,369, filed on Aug. 19, 2014.

(51) Int. Cl. G05B 19/418

(52) U.S. Cl. CPC G05B 19/418; G05B 2219/32097

(57) ABSTRACT

Embodiments of the present invention provide systems, apparatus, and methods for protecting processing recipes. Embodiments include a remote host external to an electronic device manufacturing facility, the remote host including a recipe editor adapted to allow creating of a protected processing recipe; a material control system (MCS) within the electronic device manufacturing facility and operable to communicate with the remote host; a master controller (MC) in communication with the MCS; and at least one processing tool in communication with the MC and including volatile memory adapted to store the protected processing recipe for execution by the processing tool. The remote host is operable to transfer the protected processing recipe to the volatile memory of the processing tool without allowing the protected processing recipe to be accessible by a user within the electronic device manufacturing facility. Numerous additional aspects are disclosed.

### RELATED APPLICATIONS

The present application claims priority to commonly owned, co-pending U.S. Provisional Patent Application No. 62/039,369 filed Aug. 19, 2014 and entitled “SYSTEMS, APPARATUS, AND METHODS FOR PROCESSING RECIPE PROTECTION AND SECURITY” which is hereby incorporated herein in its entirety for all purposes.

### FIELD

The present invention relates to processing recipes used in electric device manufacturing chambers, and more specifically to systems, apparatus, and methods for the protection and security of the processing recipes.

### BACKGROUND

Frequently, the owners or operators of large scale production electronic device manufacturing facilities build electronic devices for other design companies (e.g., “fabless” semiconductor design companies). The design companies develop such devices but either do not have their own manufacturing facilities or opt to have their devices built externally for cost or other reasons. Conventionally, the design companies contract with the manufacturing companies and disclose the designs and methods of manufacturing the designs to the manufacturing companies.

The design companies are usually forced to rely on the manufacturing companies to maintain the confidential processing recipe information and the manufacturing companies are burdened with having to protect the secrecy of the processing recipes. The consequences of a processing recipe becoming public or ending up in a competitor's hands can be extremely costly for both the design company and the manufacturing company. Thus, what is needed are improved systems, apparatus, and methods for processing recipe protection and security.

### SUMMARY

In some embodiments, the present invention provides a system for protecting processing recipes. The system includes a remote host external to an electronic device manufacturing facility, the remote host including a recipe editor adapted to allow creating of a protected processing recipe; a material control system (MCS) within the electronic device manufacturing facility and operable to communicate with the remote host; a master controller (MC) in communication with the MCS; and at least one processing tool in communication with the MC and including volatile memory adapted to store the protected processing recipe for execution by the processing tool. The remote host is operable to transfer the protected processing recipe to the volatile memory of the processing tool without allowing the protected processing recipe to be accessible by a user within the electronic device manufacturing facility.

In other embodiments, the present invention provides a method for protecting processing recipes. The method includes creating a processing recipe for execution on a specified processing tool within an electronic device manufacturing facility using a recipe editor executing on a remote host external to the electronic device manufacturing facility; associating the processing recipe with an attribute that indicates the recipe is a protected processing recipe; and transferring the protected processing recipe to a volatile memory of the specified processing tool within the electronic device manufacturing facility without allowing the protected processing recipe to be user accessible within the electronic device manufacturing facility.

In yet other embodiments, the present invention provides a system. The system includes a processor; and a memory adapted to store instructions, the instructions executable on the processor. The instructions include create a processing recipe for execution on a specified processing tool within an electronic device manufacturing facility using a recipe editor executing on a remote host external to the electronic device manufacturing facility; associate the processing recipe with an attribute that indicates the recipe is a protected processing recipe; and transfer the protected processing recipe to a volatile memory of the specified processing tool within the electronic device manufacturing facility without allowing the protected processing recipe to be user accessible within the electronic device manufacturing facility.

Still other features, aspects, and advantages of the present invention will become more fully apparent from the following detailed description, the appended claims, and the accompanying drawings by illustrating a number of exemplary embodiments and implementations, including the best mode contemplated for carrying out the present invention. Embodiments of the present invention may also be capable of other and different applications, and its several details may be modified in various respects, all without departing from the spirit and scope of the present invention. Accordingly, the drawings and descriptions are to be regarded as illustrative in nature, and not as restrictive. The drawings are not necessarily drawn to scale. The description is intended to cover all modifications, equivalents, and alternatives falling within the spirit and scope of the claims.

### BRIEF DESCRIPTION OF THE DRAWINGS

FIG. 1 is a schematic block diagram depicting an example electronic device manufacturing system according to embodiments of the present invention.

FIG. 2 is a screen shot depicting an example recipe editor interface according to embodiments of the present invention.

FIG. 3 is a screen shot depicting an example listing of recipes according to embodiments of the present invention.

FIG. 4 is a flowchart illustrating an example method of protecting a processing recipe according to embodiments of the present invention.

### DETAILED DESCRIPTION

Embodiments of the present invention provide systems, apparatus, and methods for securing and protecting processing recipes used to control electronic device manufacturing systems such as processing chambers. Existing electronic device manufacturing facilities typically include a plurality of processing tools (e.g., processing chambers) that operate under the control of a Master Controller (MC). The MC is a computer that receives processing recipes to be executed by the processing chambers from a local host computer called a Material Control System (MCS). The MCS provides a local tool software interface (LTSI) that allows users to define the processing to be performed on substrates using the processing tools. In some embodiments, the MC can alternatively or additionally provide the LTSI. The LTSI, whether running on the MCS and/or MC can include a recipe editor and the processing to be performed by the MC using the processing tools is called a processing recipe. A processing recipe includes one or more sequences of processing steps that define the processing environment within the chambers of processing tools that the material (e.g., substrates) being processed experiences during processing. The processing recipes are typically identified with a name and/or a Process Program Identifier (PPID). The process recipes can specify various processing parameters of the processing tools for each step such as deposition time, power set point, gas pressure, etc.

When a manufacturing process is developed by a design company that includes one or more processing recipes, the details of the processing recipes are regarded as valuable intellectual property and typically, the processing recipes are kept confidential. However, when the design company wanted to contract to have a manufacturing company use the design company's processing recipes to drive the manufacturing company's equipment, prior art systems required disclosure of the processing recipes to the manufacturing company. Such disclosure can have severe negative consequences.

Embodiments of the present invention provide systems, apparatus and methods that allow an external design company, for example, to securely transfer processing recipes to the MCS of a manufacturing company, and further to allow the manufacturing company to execute the processing recipes internally on their processing tools without being able to view or otherwise access information about the protected processing recipes of the external design company. Thus, embodiments of the invention allow externally provided processing recipes to remain undisclosed and therefore protected. Further, embodiments concurrently allow normal operation of the manufacturing system with conventional internally generated processing recipes that are not protected.

Embodiments of the present invention are implemented using two different categories of processing recipes. The first category includes unprotected processing recipes that can be created, viewed and edited using the recipe editor running as part of the LTSI on the MC or MCS. These recipes can be stored locally on, for example, the MC (e.g., on a hard disk) and accessed at will.

The second category of processing recipes includes protected processing recipes. Protected processing recipes cannot be created, viewed, edited or stored on the MC or MCS. Protected processing recipes can only be transferred through the MC (and MCS) to the volatile memory of a processing tool. In other words, embodiments of the present invention enable receipt of protected processing recipes from an external system (e.g., a remote host) and without storing the protected processing recipes in any user accessible location on the MC or MCS, the protected processing recipes are securely transferred into the volatile memory space of the processing tools. Thus, within the electronic device manufacturing facility, the protected processing recipes only ever exist for any significant time in a specific processing tool's volatile memory that is not user accessible. In some embodiments however, a “placeholder” unprotected processing recipe may be stored in the user accessible areas of the MC or MCS to represent the otherwise inaccessible protected processing recipe.

Further, even in embodiments where protected processing recipe data is temporarily written to a non-volatile storage device as part of a file transfer process, the protected processing recipe is immediately deleted upon completion of the transfer. For example, when a remote host sends a protected processing recipe to a processing tool, the recipe may be written to the hard drive of the MC in order for the processing tool to subsequently download the file into its volatile memory. The file will however be immediately deleted from the MC's drive once it has been downloaded to the processing tool. In some embodiments, a remote host transfers protected recipes to the MC with a processing tool specified as the ultimate destination of the recipe. In some embodiments, when the system (e.g., the MC) is rebooted, all of the protected processing recipes are deleted from the processing tools. Thus, when the system is initialized, the protected processing recipes are transferred from the remote host to the processing tools.

In some embodiments, the name of a protected processing recipe can be retrieved from an individual processing tool for display in the recipe editor on the MCS but without the recipe itself. In other words, the recipe editor can display a placeholder name for protected processing recipes, along with unprotected processing recipes, in a list of processing recipes that are loaded on a processing tool. However, the recipe editor cannot retrieve or display any of the process sequences/steps or parameters of the protected processing recipes. In some embodiments, the placeholder name can be a fake name selected to hide the real name of the protected processing recipe.

In some embodiments, protected processing recipes can only be created, deleted, and overwritten by a remote host. If the remote host transfers a protected processing recipe to a particular tool, and the recipe has the same name as an existing processing recipe on the particular processing tool, the existing processing recipe will be overwritten with the new recipe in the tool's volatile memory space. In some embodiments, the number of protected processing recipes that can be stored within a tool's volatile memory space can be limited. For example, the number of recipes that can be stored may limited to ten. Other limits can be used.

In some embodiments, the remote host can retrieve the number of protected processing recipes that are loaded on a particular processing tool. In other words, the current processing recipe count of a processing tool can be obtained by a remote host. Note that the name of a protected processing recipe can include an attribute that includes a processing tool identifier that specifies the particular tool within which the recipe will be executed. The remote host can use the processing tool identifier in the recipe's name to retrieve the recipe count of a particular chamber.

In some embodiments, the system may record and track events that indicate the status of the various components of the system. For example, whenever a protected processing recipe is created, deleted, overwritten or executed, a system event can be created, e.g., to track these changes in an event log. In some embodiments, the system can log execution of protected processing recipes differently than execution of unprotected processing recipes. For example, a symbol can be included next to the name of the executed protected processing recipes and a different symbol can be included next to the name of the executed unprotected processing recipes in a list of executed recipes. In some embodiments the indication that an executed recipe is a protected processing recipe can be subtle. For example, an additional space before and/or after a protected processing recipe's name can be included in the log of process events.

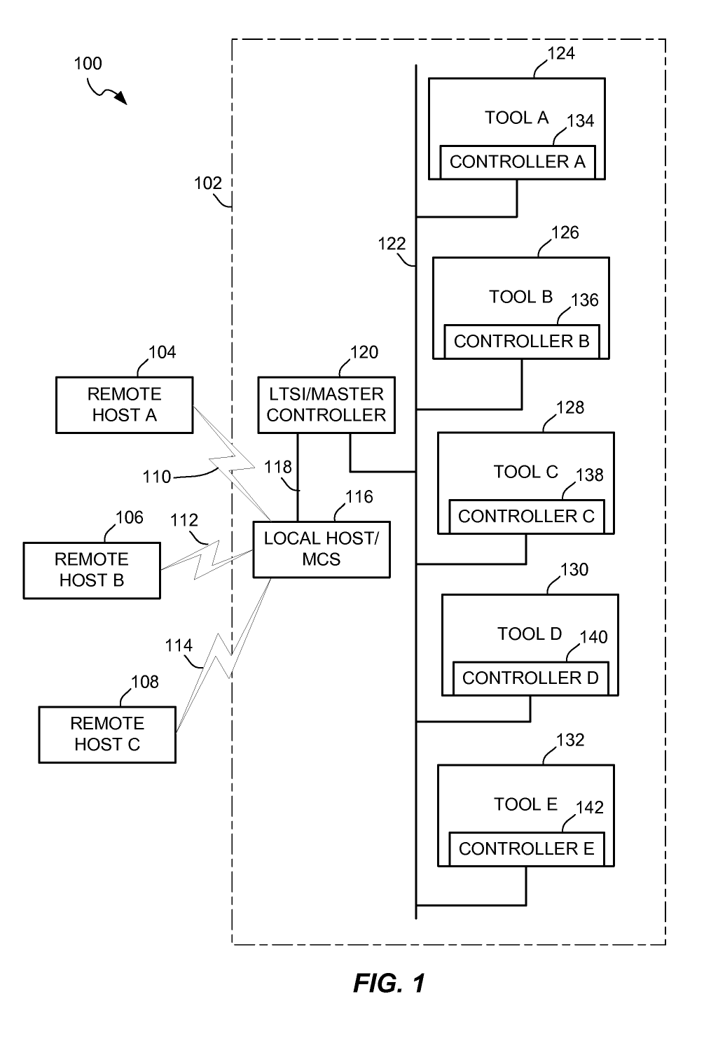

Turning now to FIG. 1, an example embodiment of an electronic device manufacturing system 100 is depicted in a block diagram. The system 100 includes a manufacturing facility 102 that can be remotely accessed by one or more remote hosts 104, 106, 108 via communication channels 110, 112, 114. The communication channels 110, 112, 114 can include any number of well know two-way communication systems including the Internet or other networks. The remote hosts 104, 106, 108 connect to a local host or MCS 116 within the manufacturing facility 102. The MCS 116 is connected via a two-way communications channel 118 (e.g., a local area network) with a local tools software interface (LTSI) running on a MC 120. The MC 120 is connected via a two-way communications channel 122 (e.g., a local area network) to a plurality of processing tools 124, 126, 128, 130, 132. Each of the processing tools 124, 126, 128, 130, 132 includes a controller 134, 136, 138, 140, 142 with associated volatile memory space. The controllers 134, 136, 138, 140, 142 can be implemented as processors and/or application specific integrated circuits (ASICs). The volatile memory space can be embodied as part of the processors/ASICs or can be separate memory modules/chips.

In operation, a remote host 104 can transmit a protected processing recipe to the volatile memory of a processing tool 124 for execution without the recipe being user accessible via the MCS 116, the MC 120, or the processing tool 124. In some embodiments, alternative configurations are possible. For example, instead of using remote hosts 104, 106, 108 to generate protected processing recipes, a remote client computer with a secure login into the MCS 116 or MC 120 can be used to run the recipe editor remotely to create protected processing recipes. The protected processing recipes can be stored on the client computer or within a secure file server within the MCS or MC.

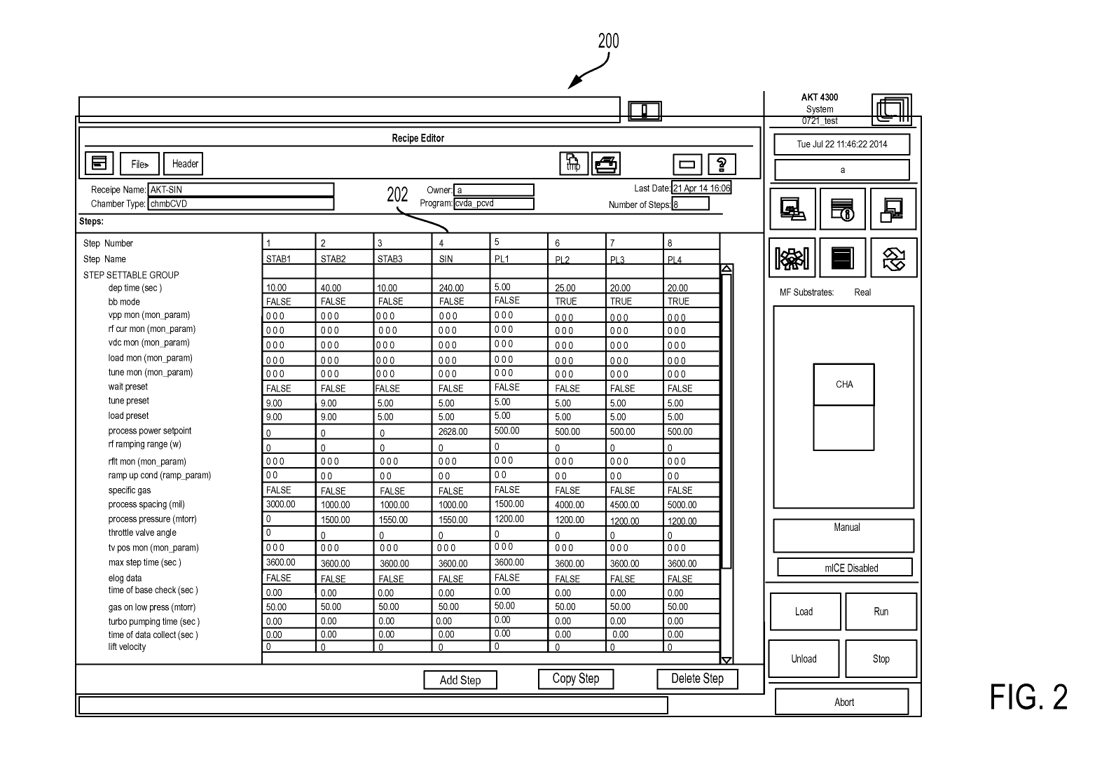

FIG. 2 is a screen shot of an example of a recipe editor interface 200 (which can be part of the LTSI). The interface 200 provides a table 202 for entering values for the process step parameters for each step of a processing recipe. The interface 200 is adapted to run on the remote hosts 104, 106, 108 to allow a user to enter and edit protected processing recipes. A similar interface that is part of the LTSI can run on the MCS 116 and/or MC 120 for entering and editing unprotected processing recipes. However, when run on the MCS 116/MC 120, the interface is adapted to not allow display or editing of protected processing recipes.

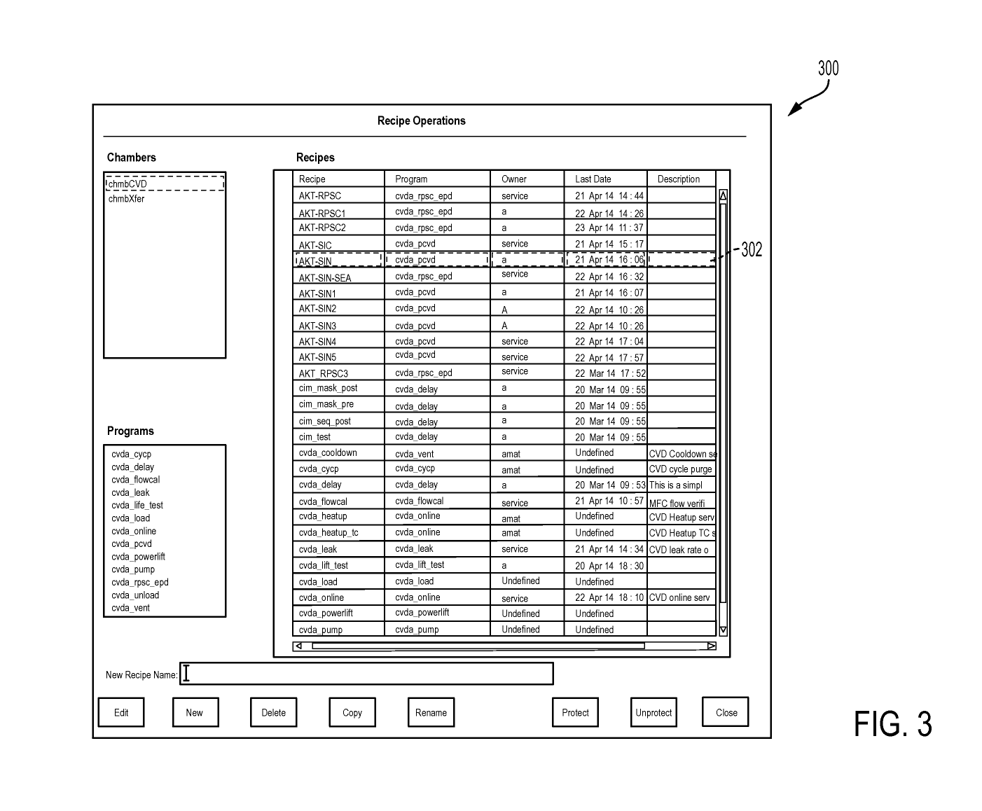

FIG. 3 is a screen shot of an example listing 300 of recipes that are available to be executed on the processing tools 124, 126, 128, 130, 132. This example listing 300 could, for example, be displayed on the MCS 116 or MC 120. Note that some of the listed recipes may just be placeholders for protected processing recipes while others may be unprotected recipes. Further, selecting an entry for an unprotected recipe and pressing the “EDIT” button will bring up the interface 200 that provides the details of the selected recipe. For example, the recipe 302 named “AKT-SIN” is selected in the listing 300 of recipes of FIG. 3 and the details of each of the eight steps of this recipe 302 are listed in the table 202 of interface 200 of FIG. 2. If however, an entry for a protected recipe was selected and the listing 300 of recipes is being displayed on the MCS 116, details of the selected recipe will not be shown. In some embodiments, instead of the protected recipe, a placeholder recipe will be shown. Thus, an external user is able to hide the fact that a protected recipe is loaded on a processing tool because a user within the manufacturing facility will be shown a placeholder recipe instead of the actual protected recipe when viewing the selected recipe 302. In some embodiments, if a protected recipe is selected and the listing 300 of recipes is being displayed on a remote host 104 however, details of the selected protected recipe will be shown.

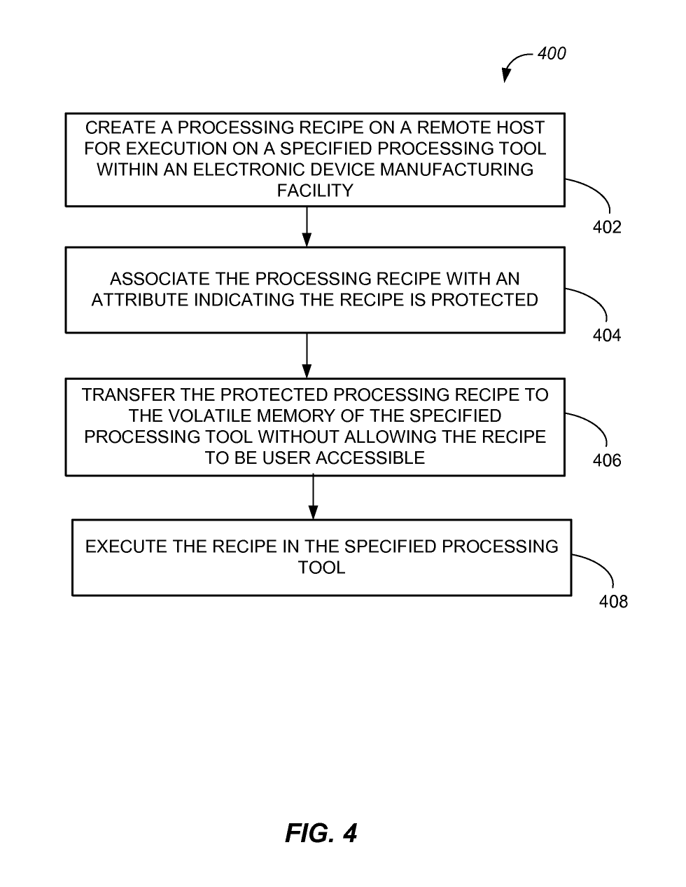

Turning now to FIG. 4, a flowchart illustrating an example method 400 of the present invention is provided. Using a remote host providing a recipe editor, a processing recipe is created for execution on a specified processing tool (402). The processing recipe is then associated with an attribute that indicates the recipe is a protected processing recipe (404). The protected processing recipe is transferred to the volatile memory of the specified processing tool within an electronic device manufacturing facility without allowing the protected processing recipe to be user accessible within the manufacturing facility (406). In some embodiments, a placeholder recipe is stored to hide the protected recipe in a listing of recipes that are currently loaded in the volatile memory of the specified processing tool. Finally, the protected processing recipe is executed in the specified processing tool (408).

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practicable. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

The foregoing description discloses only example embodiments of the invention. Modifications of the above-disclosed apparatus, systems and methods which fall within the scope of the invention will be readily apparent to those of ordinary skill in the art.

Accordingly, while the present invention has been disclosed in connection with exemplary embodiments thereof, it should be understood that other embodiments may fall within the spirit and scope of the invention, as defined by the following claims.

The invention claimed is:

1. A system for protecting a processing recipe, the system comprising:
a remote host external to an electronic device manufacturing facility, the remote host including a recipe editor adapted to allow creating of a protected processing recipe;
a material control system (MCS) within the electronic device manufacturing facility and operable to communicate with the remote host;
a master controller (MC) in communication with the MCS; and
at least one processing tool in communication with the MC and including volatile memory adapted to store the protected processing recipe for execution by the processing tool,
wherein the remote host is operable to transfer the protected processing recipe to the volatile memory of the processing tool without allowing the protected processing recipe to be accessible by a user within the electronic device manufacturing facility.

2. The system of claim 1 further including an interface running on the MCS or MC adapted to provide a listing of processing recipes including protected processing recipes.

3. The system of claim 2 wherein the listing of processing recipes provides access to unprotected processing recipe details and does provide access to protected processing recipe details.

4. The system of claim 1 wherein protected processing recipes can only be overwritten by the remote host.

5. The system of claim 1 wherein protected processing recipes are deleted from the processing tool when the MC is rebooted.

6. The system of claim 1 wherein protected processing recipes are downloaded to the processing tool when the MC is initialized.

7. The system of claim 1 wherein unprotected processing recipes can be accessed and edited by users within the electronic device manufacturing facility.

8. A method for protecting a processing recipe, the method comprising:
creating a processing recipe for execution on a specified processing tool within an electronic device manufacturing facility using a recipe editor executing on a remote host external to the electronic device manufacturing facility;
associating the processing recipe with an attribute that indicates the recipe is a protected processing recipe; and
transferring the protected processing recipe to a volatile memory of the specified processing tool within the electronic device manufacturing facility without allowing the protected processing recipe to be user accessible within the electronic device manufacturing facility.

9. The method of claim 8 further including executing the protected processing recipe in the specified processing tool.

10. The method of claim 8 further including executing an interface on an MCS adapted to provide a listing of processing recipes including protected processing recipes.

11. The method of claim 10 wherein the listing of processing recipes provides access to unprotected processing recipe details and does provide access to protected processing recipe details.

12. The method of claim 8 further including overwriting protected processing recipes via the remote host.

13. The method of claim 8 further including deleting protected processing recipes from the processing tool when a MC of the electronic device manufacturing facility is rebooted.

14. The method of claim 13 further including downloading protected processing recipes to the processing tool when the MC is initialized.

15. The method of claim 8 further including accessing and editing unprotected processing recipes by users within the electronic device manufacturing facility.

16. A system comprising:
a processor; and
a memory adapted to store instructions, the instructions executable on the processor, and wherein the instructions include:
create a processing recipe for execution on a specified processing tool within an electronic device manufacturing facility using a recipe editor executing on a remote host external to the electronic device manufacturing facility;
associate the processing recipe with an attribute that indicates the recipe is a protected processing recipe; and
transfer the protected processing recipe to a volatile memory of the specified processing tool within the electronic device manufacturing facility without allowing the protected processing recipe to be user accessible within the electronic device manufacturing facility.

17. The system of claim 16 wherein the instructions further include an instruction to overwrite protected processing recipes.

18. The system of claim 16 wherein the instructions further include an instruction to download protected processing recipes to the processing tool when a MC within the electronic device manufacturing facility is initialized.

19. The system of claim 16 wherein the instructions further include an instruction to retrieve a listing of the protected processing recipes stored in the volatile memory of the specified processing tool.

20. The system of claim 16 wherein the instructions further include an instruction to retrieve a count of the protected processing recipes stored in the volatile memory of the specified processing tool.
